(19) United States
(12) Patent Application Publication
(10) Pub. No.: US 2025/0131267 A1
(43) Pub. Date: Apr. 24, 2025

(54) SYSTEMS, DEVICES, AND METHODS FOR IMPROVING BALANCING IN NEURAL NETWORKS WITH SPARSE MIXTURE OF EXPERTS LAYER

(71) Applicant: Georges Raif HARIK, Palo Alto, CA (US)

(72) Inventor: Georges Raif HARIK, Palo Alto, CA (US)

(21) Appl. No.: 18/924,274

(22) Filed: Oct. 23, 2024

Related U.S. Application Data
(60) Provisional application No. 63/592,680, filed on Oct. 24, 2023.

(51) Int. Cl. G06N 3/08; G06N 3/045

(52) U.S. Cl. CPC G06N 3/08; G06N 3/045

(57) ABSTRACT

Disclosed herein are systems, devices, and methods for improving balancing in neural networks with at least one sparse mixture of experts (sMoE) layer. In some aspects, such improvements can be made during the pre-training phase of the neural network. For example, a method of pre-training such a neural network can comprise calculating a new non-differentiable component of an auxiliary loss function, multiplying the new non-differentiable component in an element-by-element manner by a differentiable component of the auxiliary loss function and summing over its dimensions to produce a raw penalty score, and multiplying the raw penalty score by a scaling factor to produce a balancing auxiliary loss.

### CROSS-REFERENCE TO RELATED APPLICATION

This application claims the benefit of U.S. Provisional Application No. 63/592,680, filed on Oct. 24, 2023, the content of which is incorporated herein by reference in its entirety.

### FIELD OF TECHNOLOGY

The present disclosure relates generally to the field of machine learning, and, more specifically, to systems, devices, and methods for improving balancing in neural networks with at least one sparse mixture of experts layer.

### BACKGROUND

Sparse mixture of experts or sparsely-gated mixture of experts (sMoE) is a conditional computation technique where parameters in a neural network are sparsely activated [1]. These parameters are sometimes skipped in processing tokens, based on a gating function of the token representation at a particular layer. A neural network with an sMoE layer usually has many “experts” (or simple feed-forward neural networks) but only run a few of them, usually one or two, per token. Such a neural network with an sMoE layer often needs an auxiliary loss function to ensure that all experts are trained equally, or a single expert might dominate and receive all of the training information and leave the others unable to compete. A common auxiliary loss function used is the Gshard loss function [2]. This auxiliary loss function has a product of a differentiable component (the gating function) and a non-differentiable component (the experts used in a minibatch). However, it has been noticed with this auxiliary loss function that the gating is unstable and often does not correspond to semantically very different tokens or samples going to different experts.

Training of these neural networks is often done using stochastic gradient descent where the training dataset is split into minibatches per accelerator card (which are typically graphical processing units (GPUs) or tensor processing units (TPUs)). A minibatch can be as small as 32 samples. If a sMoE layer has, for example, 128 experts and insists on a balance per minibatch, the auxiliary loss function can sometimes cause all 128 experts to be used on the 32 samples. When the 32 samples are from 32 different domains (because each sample is semantically coherent), this can cause the experts to erroneously specialize using non-semantic distinctions, for example syntactic, lexical, or grammatical distinctions.

Therefore, a new training approach is needed that does not cause the experts of a sMoE neural network layer to specialize using non-semantic distinctions but allows all of the experts, assuming the optimization requires it, to specialize in any way they want, whether it be syntactic, grammatical, or semantic. This new training approach will be important as the number of experts in prevailing neural networks increases and usage of neural networks with sMoE layers in general increases.

### SUMMARY

Disclosed herein are systems, devices, and methods for improving balancing in neural networks with at least one sparse mixture of experts layer. In one aspect of the disclosure, a method of pre-training a neural network is disclosed. The method can comprise calculating an exponential moving average of a non-differentiable component of an auxiliary loss function over multiple minibatches of training data and over multiple accelerator units to obtain a new non-differentiable component, multiplying the new non-differentiable component in an element-by-element manner by a differentiable component of the auxiliary loss function and summing over its dimensions to produce a raw penalty score, and multiplying the raw penalty score by a scaling factor to produce a balancing auxiliary loss. The auxiliary loss function can be used to balance expert utilization in a sparse mixture of experts (sMoE) layer or subnetwork of a neural network;

In some aspects, the method can further comprise adding the balancing auxiliary loss to a neural network loss of the neural network.

In some aspects, the step of calculating the exponential moving average of the non-differentiable component of the auxiliary loss function over at least one of the multiple minibatches of training data and over the multiple accelerator units can further comprise: sampling from a probability distribution representing a differentiable component of the auxiliary loss function to obtain expert assignments, summing the expert assignments over the multiple accelerator units to generate a vector of assignments over a present minibatch, multiplying each assignment from the vector of assignments by one minus the decay rate (1.0−decay rate) to obtain an adjusted vector of assignments over the present minibatch, multiplying the decay rate by the exponential moving average of the vector of assignments over previous minibatches to obtain an adjusted exponential moving average of the vector of assignments over the previous minibatches, and adding the adjusted exponential moving average of the vector of assignments over the previous minibatches to the adjusted vector of assignments over the present minibatch to obtain a new non-differentiable component for the present minibatch. The new non-differentiable component is an exponential moving average over the non-differentiable component of the auxiliary loss function.

In some aspects, the method can further comprise multiplying one minus the decay rate (1.0−decay rate) by the vector of assignments over the current minibatch and adding the product of multiplying one minus the decay rate (1.0−decay rate) by the vector of assignments over the current minibatch to the adjusted exponential moving average of the vector of assignments over the previous minibatches.

In some aspects, the exponential moving average can be calculated over between two and 256,000 minibatches of training data. In other aspects, the exponential moving average can be calculated over one minibatch if this exponential moving average is calculated over at least two accelerator units.

In some aspects, the exponential moving average can be calculated over between two accelerator units and 10,000 accelerator units. In other aspects, the exponential moving average can be calculated over one accelerator unit if this exponential moving average is calculated over at least two minibatches.

In some aspects, the accelerator units can be graphics processing units (GPUs), tensor processing units (TPUs), or a combination thereof.

In some aspects, the differentiable component can be a gating function.

In some aspects, the neural network can be a transformer neural network.

In some aspects, the transformer neural network can be a large language model (LLM).

In another aspect of the disclosure, a system for pre-training a neural network is disclosed comprising one or more computing devices comprising one or more processors programmed to calculate an exponential moving average of a non-differentiable component of an auxiliary loss function over at least one of multiple minibatches of training data and over multiple accelerator units to obtain a new non-differentiable component, multiply the new non-differentiable component in an element-by-element manner by a differentiable component of the auxiliary loss function and summing over its dimensions to produce a raw penalty score, and multiply the raw penalty score by a scaling factor to produce a balancing auxiliary loss. The auxiliary loss function can be used to balance expert utilization in a sMoE layer or subnetwork of a neural network.

In yet another aspect of the disclosure, a non-transitory computer-readable medium is disclosed comprising computer-executable instructions stored thereon. The instructions can comprise calculating an exponential moving average of a non-differentiable component of an auxiliary loss function over at least one of multiple minibatches of training data and over multiple accelerator units to obtain a new non-differentiable component, multiplying the new non-differentiable component in an element-by-element manner by a differentiable component of the auxiliary loss function and summing over its dimensions to produce a raw penalty score, and multiplying the raw penalty score by a scaling factor to produce a balancing auxiliary loss. The auxiliary loss function can be used to balance expert utilization in a sparse mixture of experts (sMoE) layer or subnetwork of a neural network.

### BRIEF DESCRIPTION OF THE DRAWINGS

FIG. 1 illustrates a method for pre-training a neural network with a sparsely-gated mixture of experts (sMoE) layer.

FIG. 2 illustrates certain steps of a method for obtaining a non-differentiable component of an auxiliary loss function of the neural network.

FIG. 3 illustrates certain machines or nodes that can be used to undertake the method disclosed herein.

### DETAILED DESCRIPTION

This disclosure describes a method and system that can be implemented as computer programs recorded or otherwise stored on one or more computer-readable media that can be executed by one or more processors of computers or servers located in one or more locations.

As previously discussed, one technical problem faced by the applicant is how to properly pre-train a neural network with a sparse mixture of experts (sMoE) layer or subnetwork such that all experts are trained equally and to prevent any one expert from dominating.

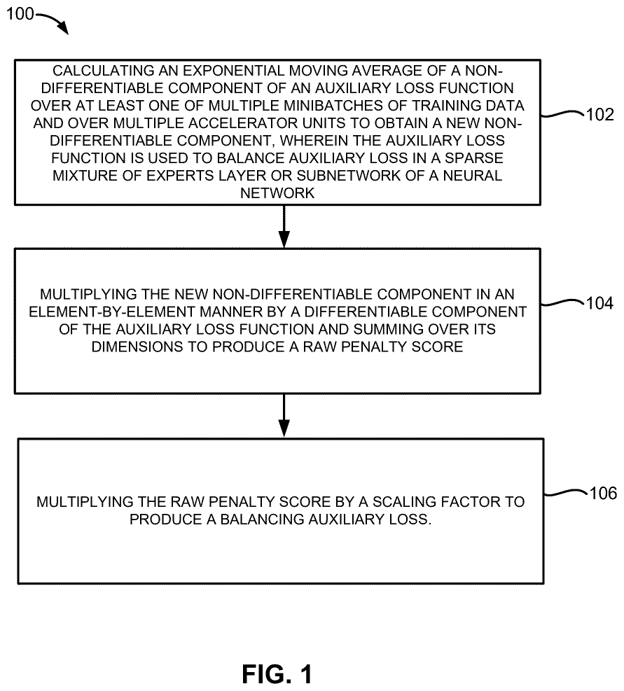

FIG. 1 is a flow diagram of an improved method 100 for pre-training a neural network with a sMoE layer. One objective of the method 100 can be to allow the SMOE layer to specialize more while still maintaining a sort of balance. In some variations, the neural network can be an autoregressive neural network. The pre-training step can be undertaken before a series of fine-tuning steps.

The neural network can be pre-trained using a gradient-based optimization algorithm. For example, the neural network can be pre-trained using a stochastic gradient descent algorithm.

The neural network can be a transformer neural network or a neural network with a transformer architecture. In some variations, the neural network can be a transformer neural network that comprises a sparse mixture of experts (sMoE) layer or subnetwork.

For example, the neural network can be a large language model (LLM) with a transformer architecture.

Pre-training an LLM can involve exposing the LLM to a large corpus of text data made up of characters. The LLM can be trained to predict a token (the next token) based on a context of one or more previous tokens. In the case of an LLM, a token can comprise a number of characters, parts of whole words, and entire whole words.

The LLM can comprise a set of parameters that define the behavior of the model. These parameters can comprise the model architecture, the model size, temperature, the number of tokens, certain hyperparameters, etc. A function can be specified using those parameters that map from any context to a probability distribution over the next token. This can be done efficiently with a large sample of tokens and using every prefix in the sample to predict the next token after the prefix.

In most cases, the LLM can be configured to generate a probability distribution for the next token to be predicted based on a sequence of tokens provided as the input. During the pre-training phase, if the next token is known, the probability of the next token can be obtained from the sample being predicted when the prefix is used as the context. One objective during the pre-training phase is to raise the probability. The way this is normally done is to calculate a gradient (vector derivative) of the log of the probability of the token with respect to the neural network parameters. By convention, the negative of this log of the probability is referred to as the neural network loss. A function used to calculate this loss is called a loss function. Minimizing this neural network loss is often part of the aim of optimizing an LLM in general to improve the predictive ability of the LLM.

However, in cases where the LLM is to be optimized for a secondary or auxiliary purpose (other than improving the predictive ability of the LLM with respect to tokens), an additional or auxiliary loss must be added to the basic neural network loss. In the present case, the secondary or auxiliary purpose is to balance the expert utilization in a sparse mixture of experts (sMoE) layer or subnetwork of the LLM.

When the secondary or auxiliary purpose is to balance the expert utilization in a sMoE layer or subnetwork, the additional or auxiliary loss can be referred to as a balancing auxiliary loss or balancing loss. A function used to calculate this balancing auxiliary loss is called an auxiliary loss function. This auxiliary loss function has a derivative or approximate derivative that can be computed with respect to the parameters of the neural network in order for the optimization to change the parameters in a way that reduces this balancing auxiliary loss. One example of an auxiliary loss is the loss discussed in Lepikhin [2].

As previously discussed, sMoE layers often need an auxiliary loss function to ensure that all experts are trained equally, or a single expert might dominate and receive all of the training information and leave the other experts unable to compete. The auxiliary loss function can be comprised of two components: (i) a differentiable component (a gating function) and (ii) a non-differentiable component comprising a vector of assignments over the experts.

For example, the non-differentiable component can be a list of how many tokens in a batch or minibatch were assigned to each expert.

The differentiable component can be a probability distribution over the total number of experts to be used (e.g., 8 experts). This can be summed up over all choices for the total number of tokens (e.g., 2000 tokens). Such a probability distribution can be computed by the neural network itself before sampling, for each token, which experts to choose. Each token can get its own probability distribution but summing up these probability distributions can result in a differentiable number, that we then divide by the number of tokens so it looks like another probability distribution (that sums up to 1). This is computed while the neural network is running from the input and the network parameters (which makes it differentiable).

As previously mentioned, this disclosure provides an improved method 100 for pre-training a neural network with a sMoE layer. More specifically, the method 100 can also be considered a new way of calculating a balancing auxiliary loss for a neural network (e.g., a LLM) with a sMoE layer.

As shown in FIG. 1, the method 100 can comprise calculating an exponential moving average of a non-differentiable component of the auxiliary loss function over multiple minibatches of training data and over multiple accelerator units to obtain a new non-differentiable component in operation 102. The method 100 can also comprise multiplying the new non-differentiable component in an element-by-element manner by a differentiable component of the auxiliary loss function and summing over its dimensions to produce a raw penalty score in operation 104.

In some variations, multiplying the new non-differentiable component in the element-by-element manner can involve an elementwise multiplication operation such as taking the Hadamard product of the new non-differentiable component and a probability distribution representing the differentiable component of the auxiliary loss function. Moreover, the dimensions, in this case, can refer to the number of experts.

The raw penalty score can have a pathwise derivative with respect to parameters of the neural network (and so can be optimized). The raw penalty score is higher when the expert assignment is more unbalanced so reducing this raw penalty score balances the assignment of experts.

The method 100 can further comprise multiplying the raw penalty score by a scaling factor to produce a balancing auxiliary loss in operation 106. In some cases, the scaling factor can be experimentally determined. For example, the scaling factor can be about 1.0×10⁻³.

The scaling factor is needed since the raw penalty score calculated in operation 104 is proportionally too large compared to the neural network loss. As such, the scaling factor is needed to scale down the raw penalty score for the optimization not to overly favor balancing the experts over the underlying task of modeling the probability distribution of the next token.

In other cases, the raw penalty score can also be adjusted or scaled down based on the number of experts.

The method 100 can further comprise an additional step of adding the balancing auxiliary loss calculated in operation 106 to the neural network loss.

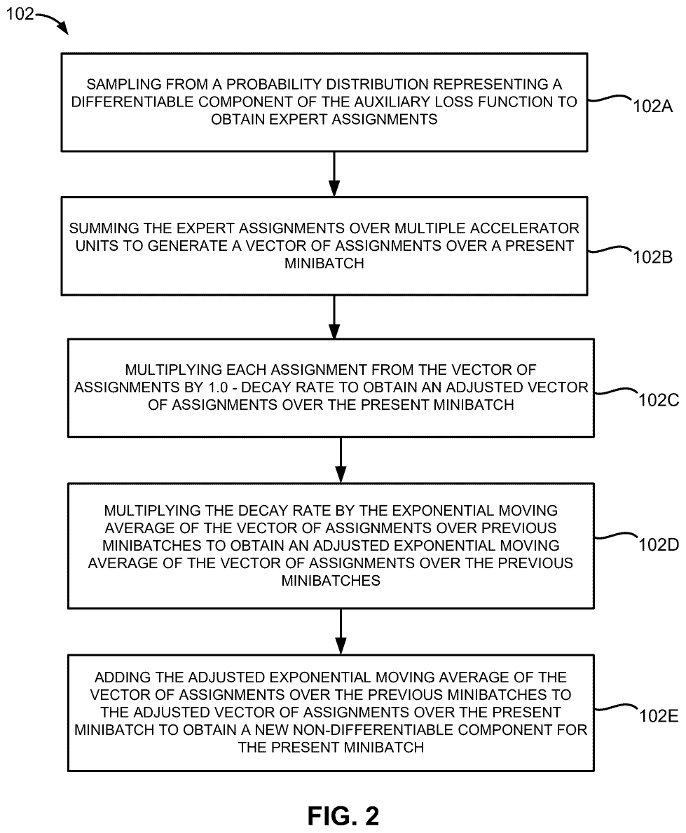

FIG. 2 illustrates that operation 102 can further comprise or be broken down into the following sub-operations: (i) sampling from a probability distribution representing a differentiable component of the auxiliary loss function to obtain expert assignments in sub-operation 102A, (ii) summing the expert assignments over multiple accelerator units (for example, all accelerator units) to generate a vector of assignments over a present minibatch in operation 102B; (iii) multiplying each assignment from the vector of assignments by one minus a decay rate (1.0−decay rate) to obtain an adjusted vector of assignments over the present minibatch in operation 102C; (iv) multiplying the decay rate by the exponential moving average of the vector of assignments over previous minibatches to obtain an adjusted exponential moving average of the vector of assignments over the previous minibatches in operation 102D; and (v) adding the adjusted exponential moving average of the vector of assignments over the previous minibatches to the adjusted vector of assignments over the present minibatch to obtain a new non-differentiable component for the present minibatch in operation 102E. This non-differentiable component being the exponential moving average over the vector of assignments of all minibatches seen, up to and including the current minibatch.

In addition, operation 102D can further comprise the steps of: (a) multiplying one minus the decay rate (1.0−decay rate) by the vector of assignments over the current minibatch, and (b) adding the product from (a) to the adjusted exponential moving average of the vector of assignments over the previous minibatches.

Operation 102 can be considered a new method for obtaining a non-differentiable component of an auxiliary loss function. This method allows the sMoE layer of the neural network to specialize more while still maintaining a sort of balance.

As a more specific example, if there are 8 experts and 2000 tokens, the assignment might be in the form of: [100, 300, 400, 200, 600, 0, 100, 300]. This would be an example of an unbalanced component, meaning that fewer than all experts were used on this batch of 2000 tokens.

In this same example where there are 8 experts and 2000 tokens, the assignment can also be in the form of: [200, 400, 100, 800, 400, 100, 0, 0]. When computing the exponential moving average, a decay factor of 0.99 can be used. For the aforementioned two assignments, the exponential moving average can be calculated as: 0.99*[100, 300, 400, 200, 600, 0, 100, 300]+0.01*[200, 400, 100, 800, 400, 100, 0, 0]=[101.0, 301.0, 397.0, 206.0, 598.0, 1.0, 99.0, 297.0]. Because this is averaging over the nondifferentiable component, we do not need to worry that the result is coming from multiple batches or minibatches. When the end result is multiplied by the differentiable component in a batch or minibatch, the result is differentiable and passes a gradient onto the differentiable component. Also, because the nondifferentiable component comes from multiple batches, its optimization does not require the balance to be over the one batch/minibatch but will still have low error if the balance over a number of batches/minibatches is good. The number of batches or minibatches affecting the average will roughly be equal to 1.0/(decay factor). So a decay factor of 100 will roughly produce a low error if there is a balance when looking at the last 100 batches (or minibatches).

For example, the exponential moving average can be calculated over between two and upwards of 256,000 minibatches of training data. Each minibatch can comprise a number of samples. A minibatch can refer to a unit of execution on one accelerator unit or over all accelerator units together. If a minibatch refers to a unit of execution over all accelerator units together then, in these cases, the exponential moving average can be calculated over 256 minibatches or less. However, if a minibatch refers to a unit of execution on one accelerator unit and there are numerous accelerator units (e.g., 10,000 accelerator units) then, in these cases, the exponential moving average can be calculated over numerous minibatches (e.g., between 10,000 minibatches and 256,000 minibatches).

Each sample can comprise a number of tokens. In some cases, each minibatch can comprise between 1 and thousands of samples. In other cases, each sample can contain between 2,000 and up to 100,000 tokens.

Also, for example, the exponential moving average can be calculated over between two and 10,000 accelerator units (or in excess of 10,000 accelerator units).

Usually, many minibatches can be run through the execution and auto-differentiation steps before running an optimizer. The number of such iterations together form what is referred to as a “batch.” For example, on one accelerator unit, 8 samples can be run at a time. This can be considered a “minibatch.” In some cases, it is not necessary to optimize after this run and gradients can continue to be accumulated. If this accumulation is done 32 times, then the size of the batch will be 256 samples.

The size of a batch usually refers to the number of samples that have been run through until the optimizer is run (which changes the neural network parameters). If there are multiple accelerator units (e.g., 8 accelerator units) then the minibatch can be considered the 8 samples on one accelerator unit or the 64 samples on all 8 accelerator units (that the execution and auto-differentiation steps can be iterated on). In cases where a minibatch refers to a unit of execution over all accelerator units together, the minibatch can be considered the aforementioned 64 samples. However, if this is accumulated over 4 minibatches before the optimizer is run, then the size of the batch will be 256 samples.

The accelerator units can be graphics processing units (GPUs). The accelerator units can also be tensor processing units (TPUs).

The applicant has discovered that accumulating the non-differentiable component of the auxiliary loss function using an exponential moving average over multiple minibatches or over multiple accelerator units does not overly reduce the balancing.

With this change, the balancing is still eventually enforced but it allows a larger set of samples to contribute to the balance than the size of a minibatch. For example, if each accelerator has four samples and a machine has eight accelerator units, then, typically, the non-differentiable assignment vector considered is over either 4 samples or 32 samples.

By aggregating it over multiple minibatches, this number can be changed to between 256 samples and 1024 samples instead. While this may slow down the rate at which balancing occurs in the optimization, this does little harm but now allows for up to 1024 experts to all have semantically different specializations.

In some cases, each batch can have 8 minibatches, each minibatch can have 4 samples, and the exponential moving average can be calculated over eight accelerator units in parallel in one machine/node.

The method 100 disclosed herein will be important as the number of experts in prevailing neural networks increases and usage of neural networks with sMoE layers in general increases.

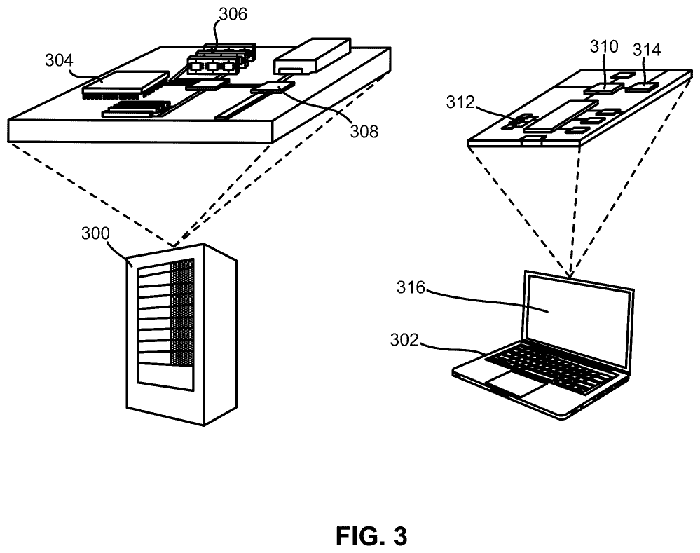

FIG. 3 illustrates an example of a server 300 or computing device 302 that can be used to perform one or more aspects of the methods described herein.

The server 300 can comprise or refer to one or more virtual servers or virtualized computing resources. For example, the server 300 can refer to a virtual server or cloud server hosted and delivered by a cloud computing platform.

The server 300 can also refer to one or more physical servers or dedicated computing resources or nodes such as a rack-mounted server, a blade server, a mainframe, or a combination thereof.

For purposes of the present disclosure, any references to the server 300 can also be interpreted as a reference to a specific component, processor, processor core, module, chip, or circuitry within the server 300.

The server 300 can comprise one or more server processors 304, server memory and storage units 306, and a server communication interface 308. The one or more server processors 304 can be coupled to the server memory and storage units 306 and the server communication interface 308 via high-speed buses or interfaces.

The one or more server processors 304 can comprise one or more CPUs, GPUs, TPUs, ASICS, FPGAs, or a combination thereof. The one or more server processors 304 can execute software instructions stored in the server memory and storage units 306 to execute the methods or instructions described herein. The one or more server processors 304 can also comprise embedded processors, processor cores, microprocessors, logic circuits, hardware FSMs, DSPs, or a combination thereof.

The server memory and storage units 306 can store software, data, tables, logs, databases, or a combination thereof. The server memory and storage units 306 can refer to an internal memory and/or an external memory, such as a memory residing on a storage node or a storage server. The server memory and storage units 306 can be a volatile memory or a nonvolatile memory. For example, the server memory and storage units 306 can comprise nonvolatile storage such as NVRAM, Flash memory, solid-state drives, hard disk drives, and volatile storage such as SRAM, DRAM, or SDRAM. The server memory and storage units 306 can store logic or instructions to perform aspects of the methods disclosed herein.

The server communication interface 308 can refer to one or more wired and/or wireless communication interfaces or modules. For example, the server communication interface 308 can be a network interface card. The server communication interface 308 can comprise or refer to at least one of a WiFi communication module, a cellular communication module (e.g., a 4G or 5G cellular communication module), and a Bluetooth®/BLE or other type of short-range communication module.

The computing device 302 can also refer to one or more dedicated desktop computers, laptop computers, tablet computers, digital assistant devices, or a combination thereof. For purposes of the present disclosure, any references to the computing device 302 can also be interpreted as a reference to a specific component, processor, module, chip, or circuitry within the computing device 302.

The computing device 302 can comprise one or more device processors 310, device memory and storage units 312, a device communication module 314 or chip, and a display 316. The device processor 310 can be coupled to the device memory 312 and the device communication module 314 through high-speed buses.

The one or more device processors 310 can comprise one or more CPUs, GPUs, TPUs, ASICs, FPGAs, or a combination thereof. The one or more device processors 310 can execute software instructions stored in the device memory and storage units 312 to execute the methods or instructions described herein. The one or more device processors 310 can also comprise embedded processors, processor cores, microprocessors, logic circuits, hardware FSMs, DSPs, or a combination thereof.

The device memory and storage units 312 can store software, data, tables, logs, databases, or a combination thereof. The device memory and storage units 312 can refer to an internal memory and/or an external memory, such as a memory residing on a storage node or a storage device. The device memory and storage units 312 can be a volatile memory or a nonvolatile memory. For example, the device memory and storage units 312 can comprise nonvolatile storage such as NVRAM, Flash memory, solid-state drives, hard disk drives, and volatile storage such as SRAM, DRAM, or SDRAM. The device memory and storage units 312 can store logic or instructions to perform aspects of the methods disclosed herein.

The device communication module 314 can comprise a wireless communication interface or chip. For example, the device communication module 314 can be a network interface card or chip of the computing device 302. In some cases, the device communication module 314 can comprise or refer to at least one of a WiFi modem or chip, a cellular communication module or chip (e.g., a 4G or 5G cellular communication module), and a Bluetooth®/BLE or other type of short-range communication module.

Due to the ever-changing nature of computers and servers, the description and depictions of the server 300 and the computing device 302 are intended only as examples for purposes of illustrating some implementations. Many other configurations of servers 300 and computing devices 302 are possible having more or fewer components than those depicted.

It will be understood by one of ordinary skill in the art that various changes and modifications can be made to this disclosure without departing from the spirit and scope of the disclosure. Elements of systems, devices, apparatus, and methods shown in the figures are exemplary and can be used in combination or otherwise on other variations within this disclosure. For example, the steps of any methods depicted in the figures or described in this disclosure do not require the particular order or sequential order shown or described to achieve the desired results. In addition, other steps or operations may be provided, or steps or operations may be eliminated or omitted from the described methods or processes to achieve the desired results. Moreover, any components or parts of any apparatus or systems described in this disclosure or depicted in the figures may be removed, eliminated, or omitted to achieve the desired results. In addition, certain components or parts of the systems, devices, or apparatus shown or described herein have been omitted for the sake of succinctness and clarity.

Accordingly, other variations are within the scope of the following claims and the specification and/or drawings may be regarded in an illustrative rather than a restrictive sense.

Each of the individual variations described and illustrated herein has discrete components and features which may be readily separated from or combined with the features of any of the other variations. Modifications may be made to adapt a particular situation, material, composition of matter, process, process act(s) or step(s) to the objective(s), spirit, or scope of the present invention.

Methods recited herein may be carried out in any order of the recited events that is logically possible, as well as the recited order of events. Moreover, additional steps or operations may be provided or steps or operations may be eliminated to achieve the desired result.

Furthermore, where a range of values is provided, every intervening value between the upper and lower limit of that range and any other stated or intervening value in that stated range is encompassed within the invention. Also, any optional feature of the inventive variations described may be set forth and claimed independently, or in combination with any one or more of the features described herein. For example, a description of a range from 1 to 5 should be considered to have disclosed subranges such as from 1 to 3, from 1 to 4, from 2 to 4, from 2 to 5, from 3 to 5, etc. as well as individual numbers within that range, for example 1.5, 2.5, etc. and any whole or partial increments therebetween.

All existing subject matter mentioned herein (e.g., publications, patents, patent applications) is incorporated by reference herein in its entirety except insofar as the subject matter may conflict with that of the present invention (in which case what is present herein shall prevail). The referenced items are provided solely for their disclosure prior to the filing date of the present application. Nothing herein is to be construed as an admission that the present invention is not entitled to antedate such material by virtue of prior invention.

Reference to a singular item, includes the possibility that there are plural of the same items present. More specifically, as used herein and in the appended claims, the singular forms “a,” “an,” “said” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Unless defined otherwise, all technical and scientific terms used herein have the same meaning as commonly understood by one of ordinary skill in the art to which this invention belongs.

Reference to the phrase “at least one of”, when such phrase modifies a plurality of items or components (or an enumerated list of items or components) means any combination of one or more of those items or components. For example, the phrase “at least one of A, B, and C” means: (i) A; (ii) B; (iii) C; (iv) A, B, and C; (v) A and B; (vi) B and C; or (vii) A and C.

In understanding the scope of the present disclosure, the term “comprising” and its derivatives, as used herein, are intended to be open-ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” “element,” or “component” when used in the singular can have the dual meaning of a single part or a plurality of parts. As used herein, the following directional terms “forward, rearward, above, downward, vertical, horizontal, below, transverse, laterally, and vertically” as well as any other similar directional terms refer to those positions of a device or piece of equipment or those directions of the device or piece of equipment being translated or moved.

Finally, terms of degree such as “substantially”, “about” and “approximately” as used herein mean the specified value or the specified value and a reasonable amount of deviation from the specified value (e.g., a deviation of up to +0.1%, +1%, +5%, or +10%, as such variations are appropriate) such that the end result is not significantly or materially changed. For example, “about 1.0 cm” can be interpreted to mean “1.0 cm” or between “0.9 cm and 1.1 cm.” When terms of degree such as “about” or “approximately” are used to refer to numbers or values that are part of a range, the term can be used to modify both the minimum and maximum numbers or values.

It will be understood by one of ordinary skill in the art that the various methods disclosed herein may be embodied in a non-transitory readable medium, machine-readable medium, and/or a machine accessible medium comprising instructions compatible, readable, and/or executable by a processor or server processor of a machine, device, or computing device. The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

This disclosure is not intended to be limited to the scope of the particular forms set forth but is intended to cover alternatives, modifications, and equivalents of the variations described herein. Further, the scope of the disclosure fully encompasses other variations that may become obvious to those skilled in the art in view of this disclosure.

### REFERENCES

[1] Shazeer, Noam, et al. “Outrageously large neural networks: The sparsely-gated mixture-of-experts layer.” arXiv preprint arXiv:1701.06538 (2017).
[2] Lepikhin, Dmitry, et al. “Gshard: Scaling giant models with conditional computation and automatic sharding.” arXiv preprint arXiv:2006.16668 (2020).

We claim:

1. A method of pre-training a neural network, comprising:
calculating an exponential moving average of a non-differentiable component of an auxiliary loss function over at least one of multiple minibatches of training data and over multiple accelerator units to obtain a new non-differentiable component, wherein the auxiliary loss function is used to balance expert utilization in a sparse mixture of experts (sMoE) layer or subnetwork of a neural network;
multiplying the new non-differentiable component in an element-by-element manner by a differentiable component of the auxiliary loss function and summing over its dimensions to produce a raw penalty score; and
multiplying the raw penalty score by a scaling factor to produce a balancing auxiliary loss.

2. The method of claim 1, further comprising adding the balancing auxiliary loss to a neural network loss of the neural network.

3. The method of claim 1, wherein calculating the exponential moving average of the non-differentiable component of the auxiliary loss function over the multiple minibatches of training data and over the multiple accelerator units further comprises:
sampling from a probability distribution representing a differentiable component of the auxiliary loss function to obtain expert assignments;
summing the expert assignments over the multiple accelerator units to generate a vector of assignments over a present minibatch;
multiplying each assignment from the vector of assignments by one minus a decay rate (1.0−decay rate) to obtain an adjusted vector of assignments over the present minibatch;
multiplying the decay rate by the exponential moving average of the vector of assignments over previous minibatches to obtain an adjusted exponential moving average of the vector of assignments over the previous minibatches; and
adding the adjusted exponential moving average of the vector of assignments over the previous minibatches to the adjusted vector of assignments over the present minibatch to obtain a new non-differentiable component for the present minibatch.

4. The method of claim 3, further comprising:
multiplying one minus the decay rate (1.0−decay rate) by the vector of assignments over the current minibatch; and
adding the product from multiplying one minus the decay rate (1.0−decay rate) by the vector of assignments over the current minibatch to the adjusted exponential moving average of the vector of assignments over the previous minibatches.

5. The method of claim 1, wherein the exponential moving average is calculated over between two and 256,000 minibatches of training data.

6. The method of claim 1, wherein the exponential moving average is calculated over between two accelerator units and 10,000 accelerator units.

7. The method of claim 1, wherein the accelerator units are at least one of graphics processing units (GPUs) and tensor processing units (TPUs).

8. The method of claim 1, wherein the differentiable component is a gating function.

9. The method of claim 1, wherein the neural network is a transformer neural network.

10. The method of claim 9, wherein the transformer neural network is a large language model.

11. A system for pre-training a neural network, comprising:
one or more computing devices comprising one or more processors programmed to:
calculate an exponential moving average of a non-differentiable component of an auxiliary loss function over at least one of multiple minibatches of training data and over multiple accelerator units to obtain a new non-differentiable component, wherein the auxiliary loss function is used to balance expert utilization in a sparse mixture of experts (sMoE) layer or subnetwork of a neural network;
multiply the new non-differentiable component in an element-by-element manner by a differentiable component of the auxiliary loss function and summing over its dimensions to produce a raw penalty score; and
multiply the raw penalty score by a scaling factor to produce a balancing auxiliary loss.

12. The system of claim 11, wherein the one or more computing devices comprising the one or more processors are further programmed to add the balancing auxiliary loss to a neural network loss of the neural network.

13. The system of claim 11, wherein the one or more computing devices comprising the one or more processors are further programmed to:
sample from a probability distribution representing a differentiable component of the auxiliary loss function to obtain expert assignments;
sum the expert assignments over the multiple accelerator units to generate a vector of assignments over a present minibatch;
multiply each assignment from the vector of assignments by one minus a decay rate (1.0−decay rate) to obtain an adjusted vector of assignments over the present minibatch;
multiply the decay rate by another vector of assignments over a previous minibatch to obtain an adjusted vector of assignments over the previous minibatch; and
add the adjusted vector of assignments over the previous minibatch to the adjusted vector of assignments over the present minibatch to obtain the new non-differentiable component.

14. The system of claim 13, wherein the one or more computing devices comprising the one or more processors are further programmed to:
multiply one minus the decay rate (1.0−decay rate) by the vector of assignments over the previous minibatch; and
add the product from multiplying one minus the decay rate (1.0−decay rate) by the vector of assignments over the previous minibatch to the adjusted vector of assignments over the previous minibatch.

15. The system of claim 11, wherein the exponential moving average is calculated over between two and 256,000 minibatches of training data.

16. The system of claim 11, wherein the exponential moving average is calculated over between two accelerator units and 10,000 accelerator units.

17. The system of claim 11, wherein the accelerator units are at least one of graphics processing units (GPUs) and tensor processing units (TPUs).

18. The system of claim 11, wherein the differentiable component is a gating function.

19. The system of claim 11, wherein the neural network is a transformer neural network.

20. The system of claim 19, wherein the transformer neural network is a large language model.

21. A non-transitory computer-readable medium comprising computer-executable instructions stored thereon, wherein the instructions comprise:
calculating an exponential moving average of a non-differentiable component of an auxiliary loss function over at least one of multiple minibatches of training data and over multiple accelerator units to obtain a new non-differentiable component, wherein the auxiliary loss function is used to balance expert utilization in a sparse mixture of experts (sMoE) layer or subnetwork of a neural network;
multiplying the new non-differentiable component in an element-by-element manner by a differentiable component of the auxiliary loss function and summing over its dimensions to produce a raw penalty score; and
multiplying the raw penalty score by a scaling factor to produce a balancing auxiliary loss.

22. The non-transitory computer-readable medium of claim 21, wherein the instructions further comprise adding the balancing auxiliary loss to a neural network loss of the neural network.

23. The non-transitory computer-readable medium of claim 21, wherein the instructions further comprise:
sampling from a probability distribution representing a differentiable component of the auxiliary loss function to obtain expert assignments;
summing the expert assignments over the multiple accelerator units to generate a vector of assignments over a present minibatch;
multiplying each assignment from the vector of assignments by one minus a decay rate (1.0−decay rate) to obtain an adjusted vector of assignments over the present minibatch;
multiplying the decay rate by another vector of assignments over a previous minibatch to obtain an adjusted vector of assignments over the previous minibatch; and
adding the adjusted vector of assignments over the previous minibatch to the adjusted vector of assignments over the present minibatch to obtain the new non-differentiable component.

24. The non-transitory computer-readable medium of claim 23, wherein the instructions further comprise:
multiplying one minus the decay rate (1.0−decay rate) by the vector of assignments over the previous minibatch; and
adding the product from multiplying one minus the decay rate (1.0−decay rate) by the vector of assignments over the previous minibatch to the adjusted vector of assignments over the previous minibatch.

25. The non-transitory computer-readable medium of claim 21, wherein the exponential moving average is calculated over between two and 256,000 minibatches of training data.

26. The non-transitory computer-readable medium of claim 21, wherein the exponential moving average is calculated over between two accelerator units and 10,000 accelerator units.

27. The non-transitory computer-readable medium of claim 21, wherein the accelerator units are at least one of graphics processing units (GPUs) and tensor processing units (TPUs).

28. The non-transitory computer-readable medium of claim 21, wherein the differentiable component is a gating function.

29. The non-transitory computer-readable medium of claim 21, wherein the neural network is a transformer neural network.

30. The non-transitory computer-readable medium of claim 29, wherein the transformer neural network is a large language model.
